(19) United States
(12) Patent Application Publication
(10) Pub. No.: US 2012/0111374 A1
(43) Pub. Date: May 10, 2012

(54) ION IMPLANTATION TOOL CLEANING APPARATUS AND METHOD

(75) Inventors: Joseph R. Despres, Middletown, CT (US); James V. McManus, Bethel, CT (US); Richard D. Chism, Round Rock, TX (US); Edward E. Jones, Woodbury, CT (US); Joseph D. Sweeney, Winsted, CT (US); Steven G. Sergi, Woodbury, CT (US); Ying Tang, Brookfield, CT (US); Michael J. Wodjenski, New Milford, CT (US); Richard S. Ray, New Milford, CT (US); Barry Lewis Chambers, Midlothian, VA (US)

(73) Assignee: ADVANCED TECHNOLOGY MATERIALS, INC., Danbury, CT (US)

(21) Appl. No.: 13/291,342

(22) Filed: Nov. 8, 2011

Related U.S. Application Data
(60) Provisional application No. 61/412,265, filed on Nov. 10, 2010.

(51) Int. Cl. B08B 3/00; G01N 25/00

(52) U.S. Cl. 134/34; 134/58 R; 422/82.12; 134/198

(57) ABSTRACT

Apparatus and methods for cleaning ion implanters and/or components thereof are described, utilizing cleaning agents reacted with residue deposits to effect removal thereof. An endpoint detection apparatus and method are also disclosed, which may be integrated in the cleaning apparatus and methods to provide highly efficient utilization of the cleaning agent and avoidance of deleterious effects that otherwise can occur when cleaning agents are continued to be exposed to an implanter or components thereof after cleaning has been completed.

### CROSS-REFERENCE TO RELATED APPLICATION

The benefit of priority under 35 USC 119 of U.S. Provisional Patent Application 61/412,265 filed Nov. 10, 2010 in the names of Joseph R. Despres, et al. for “Ion Implantation Tool Cleaning Apparatus and Method” is hereby claimed. The disclosure of such provisional U.S. patent application is herby incorporated herein by reference, for all purposes.

### FIELD

The present disclosure relates to apparatus and methods for cleaning one or more components of at least one ion implantation system, as well as to an end-point detection apparatus for use during cleaning of an ion implantation system.

### BACKGROUND

Ion implantation is used extensively in integrated circuit fabrication to accurately introduce controlled amounts of dopant species into semiconductor wafers, as a basic process in microelectronic/semiconductor manufacturing. In the operation of ion implantation systems, an ion source ionizes a dopant source material and ions are extracted from the source in the form of an ion beam of desired energy. Extraction is achieved by applying a high voltage across suitably shaped extraction electrodes, which incorporate apertures for passage of the extracted beam. The resulting ion beam is directed at the surface of a workpiece, such as a semiconductor wafer, in order to implant the workpiece with the selected dopant species, which penetrate the surface of the workpiece to form a region of desired conductivity.

Various types of ion sources are commonly used in commercial ion implantation systems, including Freeman and Bernas types using thermoelectrodes and powered by electric arcs, microwave types using magnetrons, indirectly heated cathode sources, and RF plasma sources, all of which typically operate in a vacuum. The ion source is correspondingly mounted in a vacuum chamber to which the dopant source material in gaseous form (commonly referred to as the “feedstock gas”) is introduced for the ionization thereof. The feedstock gas thereby yields an ionized plasma including positive and negative ions for the aforementioned extraction to form a collimated ion beam. Feedstock gases can include, without limitation, BF₃, B₁₀H₁₄, B₁₂H₂₂, PH₃, AsH₃, PF₅, AsF₅, H₂Se, N₂, Ar, GeF₄, SiF₄, O₂, H₂, and GeH₄.

The art is continually focused on the development and improvement of ion implantation systems. Increasing wafer sizes, decreasing critical dimensions, and growing circuit complexity are placing increasingly greater demands on ion implant tools, with respect to the need for highly efficient process control, delivery of high beam currents at low energies, and minimizing mean time between failures (MTBF).

Various parts of the ion implanter tool that require periodic maintenance include, without limitation, the source chamber and internal components (e.g., the ion source, the extraction electrodes, and high voltage insulators), turbo pumps, forelines and beam-lines. Although ideally all feedstock gas molecules would be ionized and extracted, in practice a certain amount of feedstock gas decomposition occurs, which results in deposition on and contamination of the components in the source chamber.

For example, germanium residues readily deposit on surfaces in the ion source region, e.g., on low voltage insulators, causing electrical short circuits, which in turn interrupt the arc required to produce thermionic electrons. This phenomenon is generally known as “source glitching.” It is a major contributor to ion beam instability, and can eventually cause premature failure of the source.

Residues also form on high voltage components, such as the source insulator or surfaces of extraction electrodes, causing energetic high voltage sparking. Such sparking also contributes to beam instability, and the energy released by sparking can damage sensitive electronic components, leading to increased equipment failures and poor MTBF.

While ion source life expectancy for specific ion implantation systems using non-halide-containing source materials can for example be on the order of 168 hours, when halide-containing materials such as GeF₄ are employed as source materials, the ion source life can be as low as 10 hours as a result of the detrimental effects of residue deposition on source operation.

A typical turbomolecular (“turbo”) pump lifetime when utilizing germanium processes in the ion implantation system is approximately 3-6 months, at the end of which time a build-up of deposits (residues) in the turbo pump can cause the pump to seize up and stop operating. In addition, the foreline, not only immediately after the source turbo pump, but along the entire piping system down through the roughing pump, may accumulate deposits heavy enough to choke the flow through the foreline and can present a hazardous condition when removing the foreline. Such buildup of deposits in the foreline can also result in combustion of deposited materials and fires inside the tool. Further residues may result from reaction of the source material with the components of the ion implantation system, depending on the conditions within the system, and accumulate on or in components of the system.

In addition to operational difficulties caused by residues in the ion implanter, significant personnel safety issues also arise from the emission of toxic or corrosive vapors when components of the ion implantation system are removed for cleaning. Such safety issues arise wherever residues are present, but are of particular concern in the ion source region since it is the most frequently maintained component of the ion implanter. To minimize down-time, contaminated ion sources are often removed from the implanter at temperatures significantly above room temperature, which increases the emission of vapors and exacerbates the safety issue.

It therefore would be advantageous to provide in situ cleaning, i.e., cleaning without disassembly of the implant tool, in a manner providing effective, selective removal of unwanted residues that are deposited throughout the implanter apparatus during implantation operation, to enhance personnel safety and enable stable, uninterrupted operation of the implantation equipment.

The utilization of known cleaning methods and systems to remove deposits from existing implanter tools that have a limited number of gas sticks or ports creates limited options for delivery of cleaning agents. Additional problems associated with in situ cleaning of the ion implant tool include the difficulty of determining end point conditions for removal of deposits and residues in the tool. Cleaning must be carried out in a safe and effective manner, and the cleaning agents employed must enable subsequent operation under low vacuum conditions, e.g., at pressures of 10⁻⁵ to 10⁻⁷ ton, without adverse effect.

### SUMMARY

The present disclosure relates to apparatus and methods for cleaning one or more components of at least one ion implantation system, having particular utility for cleaning existing ion implantation systems providing limited ports or flow circuits for introduction of cleaning agents. The present disclosure also relates to end-point detection apparatus for use in ion implantation system cleaning operations.

In one aspect, the disclosure relates to a unitary cleaning apparatus for delivery of a cleaning agent to an ion implanter or component thereof, said apparatus comprising a housing, and structurally associated with said housing (i) at least one cleaning agent supply vessel, (ii) cleaning agent flow circuitry coupled to said at least one cleaning agent supply vessel, and (iii) a processor and controller components assembly adapted to effect dispensing cleaning agent from said at least one cleaning agent supply vessel for passage through said flow circuitry to said ion implanter or component thereof.

In another aspect, the disclosure relates to a ion implanter including a housing defining an enclosed interior volume, with a unitary cleaning apparatus as described above, operatively arranged in said interior volume for cleaning of the ion implanter or a component thereof, or positioned on a surface of or in proximity to the housing and operatively coupled with the ion implanter for cleaning of the implanter or a component thereof.

A further aspect of the disclosure relates to an endpoint detection system for a reactive gaseous cleaning agent cleaning operation, comprising an insert adapted for placement in an effluent stream of the cleaning operation and including a material exothermically reactive with the gaseous cleaning agent, said insert including a thermal monitoring element adapted to sense a temperature condition of said material indicative of presence of the cleaning agent in contact with said material.

A still further aspect of the disclosure relates to a method of cleaning an ion implanter or component thereof, comprising flowing a cleaning agent to the ion implanter or component thereof from a source of said cleaning agent while operating a fluid delivery stick of the ion implanter in a manner enabling the cleaning agent to be flowed to said ion implanter or component thereof in place of or in addition to fluid delivered by said fluid delivery stick.

In one aspect, the disclosure relates to a method of cleaning one or more components of at least one ion implantation system, the method comprising: connecting a cleaning agent delivery system to an existing port of the at least one ion implantation system; introducing a cleaning agent from the cleaning agent delivery system into the at least one ion implantation system through the existing port; contacting the cleaning agent with deposits in the at least one ion implantation system under conditions effecting at least partial removal of said deposits; detecting an endpoint of cleaning; and responsively terminating delivery of the cleaning agent.

In another aspect, the invention relates to a cleaning assembly that is selectively coupleable with one or more components of at least one ion implantation system for cleaning thereof, said assembly comprising: at least one cleaning agent container and manifold arranged to deliver a cleaning agent to the one or more components of the at least one ion implantation system; and a flow control device for introducing said cleaning agent; wherein the assembly is adapted to be connected to an existing port of the at least one ion implantation system.

In a further aspect, the invention relates to an end-point detection apparatus for use with an ion implantation system during cleaning with a cleaning agent, said apparatus comprising: a thermal monitoring element coated or arranged to be coated with a material exothermically reactive with the cleaning agent, wherein the element is coupled to the ion implantation system.

Other aspects, features and embodiments of the disclosure will be more fully apparent from the ensuing disclosure and appended claims.

### BRIEF DESCRIPTION OF THE DRAWINGS

FIG. 1 is a schematic representation of a unitary cleaning apparatus according to one embodiment of the present disclosure, as coupled to a four gas stick ion implanter.

FIG. 2 is a perspective semi-transparent view of a unitary cleaning apparatus according to another embodiment of the disclosure.

FIG. 3 is a perspective view of various components of an ion implanter.

FIG. 4 is a perspective semi-transparent view of an integrated unitary cleaning apparatus according to another embodiment of the disclosure.

FIG. 5 is a perspective semi-transparent view of an ion implanter and an integrated unitary cleaning apparatus of the type illustrated in FIG. 4, showing alternative locations of the ion implanter at which the integrated unitary cleaning apparatus can be mounted.

FIG. 6 is a perspective view of an operator interface panel for the unitary cleaning apparatus of the disclosure.

FIG. 7 shows an electrical control box of the unitary cleaning apparatus, arranged adjacent to the fluid supply assembly of the cleaning apparatus.

FIG. 8 is a perspective semi-transparent view of a mobile unitary cleaning apparatus, according to another embodiment of the disclosure.

FIG. 9 is a perspective semi-transparent view of an ion implanter and the mobile unitary cleaning apparatus of FIG. 8, showing the positioning of the mobile apparatus in relation to the ion implanter.

FIG. 10 is a schematic representation of an illustrative end point detection system that may be usefully employed with the unitary cleaning apparatus of the disclosure.

### DETAILED DESCRIPTION

The present disclosure relates to apparatus and methods for cleaning one or more components of at least one ion implantation system, and to an end-point detection apparatus for use during cleaning of an ion implantation system to determine end-point of such cleaning

Such apparatus and methods may employ a gas-phase reactive material as the cleaning agent. The cleaning agent may be of any suitable type, and can for example comprise a halide compound, e.g., a compound containing fluorine, which is useful to effect removal of material deposits from ion implanter systems and components. The cleaning agent is usefully employed in a fluid, e.g., gaseous or vapor, form, and ionic form or plasma form in various embodiments of the disclosure. In various preferred embodiments of the disclosure, the cleaning agent comprises xenon difluoride (XeF₂).

As used herein, “ion source region” in reference to an ion implanter, includes the vacuum chamber, the source arc chamber, the source insulators, the extraction electrodes, the suppression electrodes, the high voltage insulators, the source bushing, the filament and the repeller electrode.

The present disclosure in various aspects contemplates a unitary cleaning apparatus adapted to be coupled to one or more ion implantation systems via one or more existing ports, or flow connections. The cleaning apparatus may be configured for use, as a unitary assembly including one or more supply vessels containing the cleaning agent, and appropriate flow circuitry adapted for delivery of the cleaning agent to the at least one ion implantation system, together with on-board and/or off-board processors and controllers for effecting cleaning operations.

In various embodiments, the unitary cleaning apparatus is adapted to deliver cleaning agent for flow through the ion implant tool while still at elevated temperature and effecting implantation in one or more substrates, so that implantation is concurrently carried out with cleaning of the tool or components thereof. Thus, the cleaning operation may be carried out without cool-down of the apparatus to ambient temperature, such as would otherwise necessitate interruption of ion implanter operation.

In other embodiments, the unitary cleaning apparatus is adapted to deliver cleaning agent during periods between active ion implantation operation, while the ion implant tool is at elevated temperature, so that cooldown to ambient temperature level is not required. Such “hot” operation likewise affords the advantage that interruption of active processing in the ion implanter is avoided or minimized, and cleanings carried out during the period in which the tool would otherwise be between successive ion implant operations.

The disclosure also contemplates use of the unitary cleaning apparatus for effecting cleaning of the ion implant tool or tools at ambient temperature of the equipment, wherein the cleaning agent is either heated to elevated temperature or likewise provided at ambient temperature.

As a further variation, the unitary cleaning apparatus can be utilized for delivery of cleaning agent to an ex-situ chamber in which components of an ion implantation system, as disassembled and removed from an ion implanter, are subjected to cleaning by contact with the cleaning agent.

Thus, the unitary cleaning apparatus can be utilized in any of a variety of modes for cleaning during active operation or during intervals of non-use of an ion implanter, as may be desired in specific implantation of the disclosure.

The unitary cleaning apparatus in various embodiments may be configured with a housing as the unit structure enclosing an interior volume, within which are provided supply vessels for the cleaning agent, associated flow circuitry for delivery of cleaning agent from the supply vessels to an ion implanter cleaning connection, which may take the form of a port, coupling, feed line, or other structure enabling the cleaning agent to be introduced to the ion implanter, or select components thereof, requiring cleaning. The unitary cleaning apparatus may further comprise processor and controller components, on board or offboard, for controlling the delivery rate, duration, temperature, pressure and composition of the cleaning agent, being flowed through the flow circuitry to the ion implanter or component thereof undergoing cleaning.

The processor and controller components may include components associated with the flow circuitry, such as flow control valves, back pressure valves, flow control orifice elements, mass flow controllers, pressure regulators, pressure sensors, temperature monitoring devices, cleaning agent analyzers, flow monitors, flow totalizers, heating components such as heat exchange tracing of flow circuitry lines, heat exchanger passages integrated with the flow circuitry lines, or other components for monitoring, analysis, or control of the cleaning agent or process variables associated therewith. Processor components may include microprocessors, programmable logic components, central processing units (CPUs), special-purpose programmed computers, general-purpose programmed computers are arranged to execute software effectuating cleaning operations, and the like, with associated displays, data outputs, wireless transmitters, and the like, whereby graphical or digital outputs can be generated and transmitted for viewing and/or use. Such processor and controller components may be adapted to effect feedback operation, whereby monitored system variables can be utilized to modulate activity of the unitary cleaning apparatus, or its extent.

The unitary cleaning apparatus can be adapted to be readily coupled to an ion implantation system via an existing port or coupling that in non-cleaning operation of the system is utilized to deliver a material utilized in ion implantation operation, such as a carrier gas, co-flow reagent, gas feedstock or other components to the implantation tool or component thereof that is to be cleaned. Such existing port or coupling, as used for connection of the unitary cleaning apparatus to the ion implanter or ion implanter component, can be of any suitable type, and can for example include a gas stick connection, gauge or instrument connection, valve or valve connection site, or any other passage, lumen, inlet or opening communicating with the ion implantation system or component thereof to be cleaned.

In one embodiment, the unitary cleaning apparatus of the disclosure is provided for cleaning of an ion implanter including flow circuitry comprising multiple gas sticks, one of which is a stick for introduction of carrier gas to the ion implanter for transport of the feed gas and resulting ionic species. In such embodiment, the unitary cleaning apparatus is configured with one or more cleaning agent supply vessels, processor and controller components, and associated flow circuitry that is adapted to be coupled with the ion implanter or a component thereof for introduction of cleaning agent thereto to effect cleaning thereof, with the processor and controller components of the unitary cleaning apparatus functioning to either (i) block the flow of carrier gas through the carrier gas stick and to effect flow of the cleaning agent through a flow path of the ion implanter through which the carrier gas would otherwise flow in the absence of such blocking, or (ii) introduce the cleaning agent to such flow path, so that the cleaning agent flows with carrier gas for cleaning of the ion implanter or the component thereof.

The carrier gas flow path thus may include the carrier gas stick, associated manifolding and flow conduits in fluid flow communication with carrier gas stick and the ion implanter or component thereof to be cleaned.

The carrier gas stick typically includes valving and/or other flow control components that may be modulated or blocked, as desired, by the processor and controller components of the unitary cleaning apparatus. The carrier gas stick, or associated manifolding and carrier gas flow conduits of the implanter, also will typically have a port, instrument fitting, coupling, or other element, by which the flow circuitry of the unitary cleaning apparatus can be coupled in fluid flow communication with the carrier gas flow path of the implanter or component to be cleaned.

For example, the associated manifolding may have an instrument fitting such as a pressure transducer interface that can be utilized as a locus for connection of the unitary cleaning apparatus, to effect the cleaning operation. In practice, then, the pressure transducer would be uncoupled from the coupling or fitting to which it is normally connected, and the flow circuitry of the unitary cleaning apparatus would be thereupon connected with such coupling or fitting, so that cleaning agent is able to be flowed from the supply vessel or vessels on board the cleaning apparatus, through the cleaning apparatus flow circuitry, and into the manifold of the ion implanter, for flow to the implanter or component thereof to be cleaned.

As mentioned, the connection of the unitary cleaning apparatus to the carrier gas flow path of the ion implanter or component to be cleaned, can be associated with action of the processor and controller components of the cleaning apparatus that block or otherwise modulate flow of carrier gas to a desired extent. For example, the processor and controller components may include an interface with the existing process monitoring and control system of the ion implanter otherwise controlling the carrier gas flow during the ion implantation operation, so that a flow control valve in the carrier gas stick is closed by actuation of associated valve actuator for such flow control valve. Alternatively, the processor and controller components may include an interface that is directly coupled with such flow control valve, or an actuator therefore, to effect closure or adjustment of the flow control valve as desired. It will be apparent that many potential arrangements can be exploited to utilize the carrier gas flow path as a path for flow of the cleaning agent to the ion implanter or component thereof to be cleaned.

By utilizing the existing flow path, and associated components, that are used for providing carrier gas flow in the operation of the ion implanter, the unitary cleaning apparatus of the present disclosure avoids the need for substantial modification of existing ion implanter systems, and leverages the existing piping, valving, etc. of the ion implanter to effect the cleaning operation in a simple and effective manner. In such manner, the existing monitoring and process control components of the ion implanter that are used for controlling the timing, duration, and extent of carrier gas flow can be used for corresponding control of the cleaning operation, as an adjunct to the processor and controller components of the unitary cleaning apparatus. In such manner, the instrumentation, components, and complexity of the processor and controller components of the cleaning apparatus can be substantially simplified, to an extent corresponding to the specific features, layout and operation of the ion implanter, as regards the carrier gas.

Accordingly, the adaptation of the unitary cleaning apparatus for such exploitation of the existing carrier gas capability of the ion implanter may be significantly varied, as regards the specific implementation, connection of the cleaning apparatus flow circuitry, specific processor and controller components, computational interfaces, signal transmission and signal processing interactions between the cleaning apparatus and the implanter process control system, such adaptation being within the skill of the art, based on the disclosure herein, as applied to specific ion implanter systems.

The unitary cleaning apparatus may correspondingly be varied in structure, confirmation, and arrangement of components, but is unitary in the sense of being constituted by fluid supply vessels, flow circuitry and processor and controller components in an assembly that is able to be coupled with an ion implanter, and operated to deliver cleaning agent to the implanter or component thereof to be cleaned.

The component to be cleaned may be of any appropriate type, and may include, for example, the ion source, ion chamber, forelines, turbo pumps, beam lines and/or other components of the ion implanter.

The cleaning agent provided in the unitary cleaning apparatus for delivery to the ion implanter or component thereof to be cleaned, may be of any suitable type that is effective to remove deposits from the ion implanter or component. Deposits can be of widely varying type, and can variously comprise, consist or consist essentially of one or more of silicon, boron, phosphorus, germanium, magnesium, arsenic, tungsten, molybdenum, selenium, antimony, indium, carbon, aluminum and tantalum, and compounds containing same. The cleaning agent may be selected to be effective to at least partially remove the deposits from the cleaning locus, in a selective manner that will not significantly affect materials of construction and components of the ion implanter, e.g., aluminum, tungsten, molybdenum, graphite, insulator materials, sealant materials, etc.

The cleaning agent may be of widely varying types. Cleaning agents potentially useful in various applications of the present disclosure include, without limitation, XeF₂, GeF₄, SiF₄, BF₃, AsF₅, AsF₃, PF₅, PF₃, F₂, TaF₃, and/or TaF₅. As a specific example, in the case of germanium doping being conducted in the ion implantation system, the cleaning agent may comprise a gas that is reactive to form a germanium fluoride intermediate product. Such cleaning gas may for example include XeF₂, SiF₄, BF₃, AsF₅, AsF₃, PF₅, and/or PF₃.

XeF₂ is a preferred cleaning agent in the broad practice of the present invention. XeF₂ will sublime at room temperature, but may be heated to increase the rate of sublimation, when such material is provided at ambient temperature. XeF₂ is an effective cleaning agent for removal of silicon, boron, arsenic and phosphorus deposits.

Although illustratively discussed above as being introduced to the ion implanter or component to be cleaned via the flow path in the implanter apparatus that is used for carrier gas, such as argon, helium, etc., it will be appreciated that the cleaning agent can be introduced to the ion implanter or component to be cleaned in any other suitable manner. For example, the cleaning agent may be introduced concurrently or sequentially through multiple ports of the ion implanter or component thereof to be cleaned. Cleaning agent introduction through passages utilized for throughput of other materials can be effected. For example, the cleaning agent may be introduced into a feedstock gas conduit, dopant delivery conduit, purging gas line, or any other ingress or access structure, arrangement or technique that is effective to transport the cleaning agent into contact with the ion implanter location or component to be cleaned. Thus, the cleaning agent may be introduced through an existing flow line or passage, in addition to or in place of the fluid normally flowed through such line or passage.

The cleaning agent may be contacted with the deposit in the location or component of the ion implanter in any appropriate contacting manner. In some embodiments, the cleaning agent is flowed continuously through the location or component of the ion implanter to effect cleaning, either with or without activation (plasma formation) of the cleaning agent. The cleaning agent may be at ambient or elevated temperature. In other embodiments, the cleaning agent may be flowed into a location or component of the ion implanter until a specific pressure is reached, with the cleaning agent thereafter being allowed to react for a predetermined time with the deposits in the location or component of the implanter, following which the cleaning agent and cleaning reaction products are withdrawn or exhausted from such location or component of the implanter. In still other embodiments, the cleaning agent may be introduced in a pulsed manner, e.g., wherein pressure of the cleaning agent as a function of time is non-linear in character, such as pulsed flow, wherein pressure describes a sawtooth wave form as a function of time, or a sinusoidal wave form, or a step-wise increase to a maximum pressure, or other time-varying form of cleaning agent introduction. The cleaning agent may be introduced for contacting during normal operation of the implanter, or during periods between successive operation of the implanter, or during down time of the ion implanter for maintenance, or in other suitable manner.

In the various modes of cleaning, the cleaning agent can be introduced at any suitable cleaning process conditions of temperature, pressure, composition (e.g., in the event that the cleaning agent comprises multiple cleaning ingredients that may be varied in relative proportions to one another, or in the event that the cleaning agent is introduced in another fluid stream in which the relative concentration of the cleaning agent to the fluid or fluid components in such fluid stream may be varied), flow rate, etc.

In general, the cleaning operation may be conducted at any suitable process conditions, including, without limitation, ambient temperatures, elevated temperatures (in excess of ambient temperature), presence of plasma, absence of plasma, sub-atmospheric pressure, atmospheric pressure, and superatmospheric pressure. Contacting of the cleaning gas with the deposit material can involve delivery of the cleaning agent in a carrier gas, in a neat form, or in mixture with a further cleaning agent, co-reactant, adjuvant, dopant, etc. The gas-phase reactive material can be heated for chemical reaction with deposits that are at ambient temperature, in order to increase the kinetics and efficacy of the cleaning action.

Specific temperatures for cleaning removal of deposits in various embodiments can range from about 0° C. to about 1600° C. and may be conducted at temperatures in various particular ranges in specific embodiments, such as temperatures in the ranges from 10° C. to 800° C., 20° C. to 500° C., 50° C. to 300° C., 400° C.-600° C., 700 to about 1600° C. or any other suitable temperature or range of temperatures. In general, temperatures may range from ambient levels, e.g., 20° C., up to 1200° C. or more, but more typically are in a range of from 20° C. to 300° C., and most preferably or in a range of from 20° C. to 70° C. Pressures may range from 0.05 Torr to 1500 Torr or more, but more typically are in a range of from 0.05 Torr to 20 Torr, and more specifically from 0.05 Torr to 4.0 Torr, particularly where graphite is present in the cleaning locus, such as is the case in many beamline components.

The duration of the cleaning operation may be from 30 seconds to one hour or more, but more typically is in a range of from about 5 min. to 30 min. In a pulsed mode of operation, the cleaning agent may be introduced at a pulse pressure in a range of from 0.1 Torr up to 100 Torr, following which the cleaning agent is allowed to “soak” the cleaning locus for a period of from 10 seconds to 5 min., subsequent to which the residual cleaning agent and cleaning reaction byproducts are evacuated from the cleaning locus, following which the process of cleaning agent introduction, soaking and evacuation may be repeated for a number of cycles, e.g., from 5 to 20 cycles.

Cleaning action, e.g., reaction of the cleaning agent with the contaminant deposit can be monitored and/or regulated, based on varying characteristics of the cleaning operation. Such characteristics can include pressure, duration, temperature, concentration, presence or absence of a particular species, rate of pressure change, rate of temperature change, rate of concentration change (of a particular species), change of current, etc. The introduction of the cleaning agent to the system can be terminated based on attainment of a predetermined characteristic of the cleaning operation, such as a predetermined pressure in the vacuum chamber, passage of a predetermined amount of time, attainment of a predetermined temperature, concentration of a specific element or compound in the system, presence of a particular by-product, reaction product or other species in the system, or realization of a predetermined current condition in the monitoring operation.

The monitoring of the process variable utilized to modulate the cleaning operation can be carried out using any suitable monitors, sensors, detectors or the like, coupled in signal transmission relationship with a central processor unit (CPU) or other controller, wherein the controller is operatively arranged and adapted to terminate the cleaning operation in response to sensing of one or more process variables and corresponding determination by the CPU or other controller that the desired extent of cleaning has been achieved.

Various methods thus may be utilized for monitoring the progress of the cleaning operation. In one operation, pressure change during the contacting of the cleaning agent with the deposit is monitored, with the contacting of the cleaning agent with residue being terminated when the pressure change with time goes to zero. Alternatively, the contacting may be conducted with monitoring of partial pressure of the cleaning agent, or partial pressure of the reactants deriving therefrom may be monitored as to partial pressure thereof, with the contacting being terminated when the monitored partial pressure reaches a predetermined value, as an endpoint.

Such endpoint monitoring can for example be carried out with a suitable endpoint monitor, e.g., an endpoint monitor of a type as more fully described in U.S. Pat. No. 6,534,007 and U.S. patent application Ser. Nos. 10/273,036; 10/784,606; 10/784,750; and 10/758,825, or a thermopile infrared (TPIR) or other infrared detector that is effective to detect the endpoint condition of pressure, composition, etc. The contacting may be conducted by controlled flow of the cleaning agent using components of the process equipment system that allow regulation of the partial pressure of gas-phase material and control of the reaction rate. Alternatively, a continuous flow of the cleaning agent, at a pre-determined flow rate, can be employed to carry out the cleaning operation. As previously discussed, the flow of cleaning agent may be continuous or intermittent in character and may include pulsatile or other cyclic flow regimes. Specifically, the flow may be laminar or turbulent in character.

The endpoint condition for the cleaning operation may be a temperature or temperature differential end point condition. Determination of a thermally determined endpoint may be important, for example, when the cleaning agent XeF₂ leaves the pump during the cleaning process, and is compressed and contacts cooler components resulting in XeF₂ condensation on tool surfaces. Such condensation can cause occlusion of restriction in the exhaust line and degrade pump performance resulting in a potentially hazardous condition.

Accordingly, thermal monitoring may be usefully employed to detect conditions that if unchecked can result in condensation in flow passages. The monitoring and control system therefore may be configured to monitor temperature in appropriate locations, and at the onset of temperature conditions that may result in condensation, the pressure, flow rate or other system variables may be altered to prevent condensation from occurring, or a heater may be employed for supplemental heat input to prevent occurrence of condensation.

Thermal monitoring may also be employed for thermal detection of endpoint conditions.

In one embodiment, endpoint is determined by thermal monitoring using an endpoint monitoring apparatus comprising a thermal monitoring element operatively arranged for transmission of a thermal monitoring signal from the thermal monitoring element to the CPU or other controller, for responsive action to terminate flow of cleaning agent to effect conclusion of the cleaning operation. The endpoint monitoring apparatus may be programmatically arranged to terminate or modify the cleaning process to accommodate varying cleaning requirements. The thermal monitoring element may be of any suitable type and can for example comprise any one of a temperature probe, thermocouple, pyrometric sensing element, or any other elements, devices or assemblies arranged to detect temperature, temperature differential or a temperature change of a particular magnitude.

In one embodiment, an endpoint detection apparatus comprises a thermal monitoring element coated with a material exothermically reactive with the cleaning agent. The endpoint detection apparatus may be arranged downstream from the component to be cleaned in the ion implantation system, with a reactive cleaning agent (e.g., XeF₂) being introduced to initiate cleaning. Thereafter, consumption of the XeF₂ of the cleaning operation will result in a relatively low concentration of such cleaning agent in the effluent discharged from the component undergoing cleaning. With continued cleaning, the cleaning agent will be present in the effluent at increasing concentration and will react with the exothermically reactive coating on the thermal monitoring element. Such exothermic reaction will involve a temperature increase, which can be sensed to generate a detection signal transmitted to the CPU for termination of the cleaning operation.

The material exothermically reactive with the cleaning agent in such thermal monitoring element can be of any suitable type. For example, materials exothermically reactive XeF₂ include, without limitation, silicon, germanium, and magnesium. When exothermically reactive material is utilized in endpoint detection arrangements, the exothermically reactive material may be arranged for temperature monitoring, or the exothermically reactive material may be provided in the form of a strand or other thin linear element that as a result of exothermic reaction is dissipated to generate the output signal for termination of the cleaning operation. Thus, a sacrificial filament may be employed as a replaced element of the monitoring and control system for the cleaning apparatus.

In another embodiment, a probe may be arranged in the ion implantation chamber for contact with the ion beam, or other environment in such implant tool, so that residue generated in the normal ion implantation operation of the ion implantation system accumulates on the surface of the probe during ion implantation, to form a coating. The coating may for example alter the conductivity, resistivity or other characteristic of the probe, which via suitable monitoring equipment can be utilized to determine when cleaning is necessary, and alternatively when the cleaning agent removes deposited material from the probe, the restoration of the normal monitoring signal indicates that a cleaned condition has been reached, whereupon the cleaning operation can be terminated. In various embodiments, temperature probes may be placed in proximity to residue-accumulating locations in the ion implanter system, or in various locations as part of a sensing array, whereby changes can be detected to determine need for cleaning or to determine when a previously commenced cleaning operation has effected a desired extent of cleaning, e.g., reached an endpoint condition of the cleaning operation.

The present disclosure also contemplates the in situ regeneration of the sensing probe, or a sensing material, by the cleaning agent, or by a specific regeneration reagent, to renew the probe or sensing material for renewed sensing operation so that it can determine when cleaning is needed and/or when cleaning is completed.

In another embodiment, the endpoint detection apparatus comprises one or more thermocouples arranged to detect a temperature differential. Such thermocouples may for example be arranged in a roughing line to facilitate temperature monitoring. In one specific implementation, a thermocouple may be employed that comprises an insert element (e.g., a tube) that may contain a reactive material on its surface. In another specific embodiment, two thermocouples may be utilized to monitor a differential temperature condition at different locations in the apparatus. When a predetermined differential temperature condition is achieved, cleaning thereupon may be terminated, or a “soak time” may be set for supplemental cleaning with the same or a different cleaning agent.

Various embodiments of endpoint detection in the cleaning operation may involve monitoring of the pressure change during a soak time (dP/dt) of the cleaning process. Once the monitored pressure stops changing with time the invariable pressure differential indicates an endpoint of then the cleaning Endpoint detection may also be carried out based on any desired implanter tool parameter, as a monitored endpoint detection variable. In one embodiment, the endpoint detection method utilizes Fourier transform infrared spectroscopy (FTIR).

The present disclosure contemplates the use of different cleaning agents used in sequence, to effect a different severity of cleaning conditions, or alternatively to utilize a cleaning agent that is best accommodated to a specific deposit, followed by another cleaning agent that is selective for removal of a different deposit material. It will be recognized that cleaning agents may be used sequentially or in a “cocktail” formulation to achieve desired levels of cleaning in various embodiments of the present disclosure.

Considering in situ cleaning in further detail, such cleaning is primarily dependent on three factors: the reactive nature of the cleaning precursor, the volatility of the cleaning reaction by-products, and the reaction conditions employed in the chemical cleaning. The cleaning composition should remove unwanted residue while minimizing wear of the materials of construction of the implanter. The byproducts generated by the cleaning reaction must be volatile enough to facilitate their removal by the vacuum system of the ion implanter or other pumping apparatus.

The cleaning of residue formed from the same material as the component(s) of the implanter does result in some wear of the component itself. Specifically, use of XeF₂ as a cleaning agent to remove tungsten deposits from a system utilizing a tungsten arc chamber will result in removal of some tungsten from the interior of the arc chamber. However, in the interest of maximizing system efficiency, loss of some of the interior material of the arc chamber is not significant when viewed in light of the decreased system performance if the system is not cleaned and the tungsten deposits are allowed to accumulate in the system.

The component(s) in the implanter apparatus that accumulate ionization-related deposits thereon during ion implantation processing in the system, can be of any suitable type, e.g., vacuum chambers, arc chambers, electrodes, filaments, high voltage bushings, magnet waveguides, wafer handling components, clamp rings, wheels, discs, etc. In one embodiment, the component is a source (e.g., vacuum) chamber and/or one or more component(s) contained therein.

The cleaning agent may be supplied in any suitable supply vessel from which the cleaning agent may be selectively dispensed for use. In applications in which the cleaning agent comprises xenon difluoride, or other solid source cleaning agent that is volatilized for use, the cleaning agent may be provided in a solid delivery vessel of a type commercially available from ATMI, Inc. (Danbury, Conn., USA) under the trademark PROE-VAP, which may be subjected to heating of the vessel to volatilize the solid phase cleaning agent, and produce the gas phase cleaning agent for dispensing from the vessel. In the vessel, the solid source cleaning agent may be provided on a porous metal support structure, or in trays stacked in the interior volume of the container, and the vessel interior volume otherwise may comprise extended surface elements to facilitate uniform heat transfer, and volatilization of the solid source cleaning agent to form the gaseous cleaning agent, when the cleaning agent supply vessel is heated.

The cleaning agent supply vessel may be equipped with a valve head containing a dispensing valve that may be manually or automatically opened to release gaseous cleaning agent for flow through the associated flow circuitry of the unitary cleaning apparatus, with the dispensing operation being managed by the processor and controller components of the unitary cleaning apparatus.

The unitary cleaning apparatus may include one or more cleaning agent supply containers. When the apparatus includes multiple supply containers, such containers may be integrated in the associated flow circuitry to enable switch-over of the vessels, from a vessel approaching exhaustion of its cleaning agent contents, to another fresh vessel containing a full charge of cleaning agent, so that cleaning operation can continue without interruption. Alternatively, the vessels may be arranged in the unitary cleaning apparatus with the processor and controller components arranged so that each vessel is monitored to determine its cleaning agent inventory during active dispensing operation, and with the processor and controller components being arranged to discontinue the dispensing operation involving a specific vessel when the monitoring indicates that the vessel is at an endpoint condition, e.g., approaching an empty state.

In one embodiment, the unitary cleaning apparatus includes an empty container detector comprising any one of a pressure sensor, flow sensor, and weight sensor. In specific embodiments, a pressure sensor may be employed to monitor rate of change of container pressure, utilizing the fact that the pressure drops faster as container nears empty, so that a predetermined rate of change or pressure drop will signal the endpoint condition as having occurred.

The processor and controller components of the unitary cleaning apparatus may be configured and constituted to provide a thermal management capability for heating of the one or more cleaning agent supply vessels, when the cleaning agent is in solid form and requires heating to volatilize from the solid a quantity of gaseous cleaning agent. The processor and controller components may therefore be arranged to provide a demand-based heating of a cleaning agent vessel, so that sufficient sublimation or volatilization occurs to satisfy the cleaning requirements of the ion implanter or the component thereof to be cleaned.

In various specific embodiments of the unitary cleaning apparatus, the processor and controller components of the apparatus are adapted to generate and transmit to the ion implanter process control system an atomic mass unit (AMU) reprogramming signal or other programming signals to accommodate the cleaning operation. For example, if the cleaning agent is introduced to the flow path in the implanter that flows argon or other carrier gas into the ion chamber, the ion implanter system settings such as AMU or other settings may be switched by the signal or signals from the unitary cleaning apparatus processor and controller components so that cleaning agent settings are commenced (e.g., for XeF₂ when xenon difluoride is used as the cleaning agent and flows through argon passages subsequent to shut-off of the argon carrier gas supply). In such manner, the unitary cleaning apparatus may be constructed and arranged to “override” the normal process controller operation of the ion implanter, or to vary or supplement it, in order to carry out the cleaning operation most effectively.

The unitary cleaning apparatus can be configured in various embodiments so that its processor and controller components provide processing and control signals to the CPU of the ion implanter process control system, e.g., for display of operational parameters and monitored conditions on a graphical user interface or other output device of such ion implanter process control system.

The processor and controller components of the unitary cleaning apparatus may also be arranged to provide docking or interlocked signals to an output display of the cleaning apparatus and/or a process control system display of the ion implanter, as a further fail-safe safety feature.

The unitary cleaning apparatus, in specific embodiments thereof, enables delivery of cleaning chemistry to the arc chamber of an ion implanter using existing equipment and gas sticks of the implanter, in which one or more gas sticks is utilized for introduction of the cleaning chemistry, and the gas stick or sticks involved may be blocked by action of the unitary cleaning apparatus, e.g., by closure of a flow control valve, or other operation serving to terminate the flow of the fluid normally transmitted through such stick(s). The processor and controller components of the unitary cleaning apparatus may provide interlock logic to effect such blocking. Alternatively, the cleaning chemistry may be co-flowed within existing equipment and gas sticks, with one of the carrier gas, dopant or other fluid flow in normal implantation operation to the implanter. By such arrangements, the implanter can operate according to predetermined operating modes while effecting cleaning operation either during ion implantation or between periods of implant operation.

In order for an ion implanter to conduct a specific recipe for ion implantation, the ion implanter must as a practical matter utilize a gas flow feedback signal to ensure that the proper gas flow is being delivered to the arc chamber of the implanter. The unitary cleaning apparatus may be adapted to switch the flow feedback signal for argon or other process gas, and to replace it with the cleaning chemistry flow control device, e.g., mass flow controller, pressure control valve, restricted flow orifice, needle valve or calibrated length of tubing. Such replacement during the cleaning operation allows the implanter mass flow controller to remain powered as well as the cleaning chemistry mass flow controller, with the cleaning chemistry mass flow controller providing an interlocked flow signal to the implanter process control system. The system and unitary cleaning apparatus may be constructed to display the cleaning chemistry mass flow controller flow rate on an ion implanter operator interface.

In a specific implementation, the unitary cleaning apparatus and the ion implanter may be arranged to employ an interlock scheme that allows safe operation. For example, the unitary cleaning apparatus may utilize air pressure supplied to the gas stick isolation valve to ensure that the implanter is in a safe operational state to run the cleaning sequence. Such interlock arrangement may further utilize an operator interface on the implanter tool, for operator verification of readiness for the cleaning operation.

Specific arrangements of the processor and controller components may be employed to damp or smooth transitions between cleaning and non-cleaning operational states, to avoid thermal shocks, pressure spikes, actuation of ion implanter alarms, etc.

The unitary cleaning apparatus may be utilized to clean an ion implanter to reduce glitching caused by residue deposits within the source chamber, e.g., on an insulator or electrode surface. If only the source chamber is to be cleaned, the source turbo isolation valve and the beam-line isolation valve of the ion implanter will typically be closed during the cleaning operation. In cleaning the turbo pumps of an ion implanter, it is desirable to introduce the cleaning agent as close to the inlet of the turbo pump as possible. Some ion implanters may allow cleaning of the turbo pumps without also cleaning the source chamber, without implanter modification, depending on the availability of existing ports on the implanter that are associated with the turbo pumps. Cleaning of the fore-line can be carried out to reduce the buildup of residue deposits on the fore-line not only immediately after the source turbo pump, but along the entire piping system down through the roughing pump (such deposits are known to have resulted in or contributed to a number of fires in various ion implanter systems).

The unitary cleaning apparatus may be utilized to clean source chambers to reduce glitching and the frequency of periodic maintenance. Cleaning of source turbo pumps, forelines, foreline turbo pumps, and beam lines, separately as well as aggregately, is contemplated by the present disclosure.

The unitary cleaning apparatus in various embodiments is provided with a purging capability, by which the flow circuitry of the apparatus may be purged prior to disconnecting and removing a cleaning agent supply vessel that has reached an endpoint and must be replaced by a fresh vessel containing the cleaning agent. For such purpose, the apparatus may include a coupling or connection on the flow circuitry by which the flow circuitry can be coupled with a source of nitrogen, or other purge gas, to effect purging of the flow circuitry. Such coupling may be adapted, for example, to connect the flow circuitry to a house nitrogen line of a semiconductor manufacturing facility.

To facilitate the ready transport and availability of the unitary cleaning apparatus of the disclosure, the same may be provided as a motive, e.g., wheeled, assembly, of a size permitting it to be manually or vehicularly moved from one location to another in the semiconductor manufacturing facility or other installation containing the ion implanters to be cleaned. The housing of the unitary cleaning apparatus may thus be arranged with attached wheels as a cart assembly, with the apparatus including a handle or hold structures affording manually-induced movement of the apparatus for transport thereof. Alternatively, the housing may include or be secured to a hitch, coupling or other structure enabling it to be interconnected with a vehicle, e.g., a battery-powered cart vehicle, to enable movement of the unitary cleaning apparatus to different locations in a facility containing multiple ion implanters located at distances from one another making such movement desirable. As a further variation, the unitary cleaning apparatus may comprise a vehicular assembly that is driveable by an operator, such as a battery-powered vehicle integrating the cleaning agent supply vessels, flow circuitry, and processor and controller components in an assembly mounted on the chassis of the vehicle, or otherwise carried by the vehicle.

As used herein, the term “housing” is intended to be broadly construed as referring to enclosing as well as non-enclosure structures. For example, the housing may be a planar platform, open tray member, or other base structure enabling the parts and components of the cleaning assembly to be located in proximity to one another to constitute a structural assembly. When the housing is constituted by an enclosure structure, the enclosure may be ventilated, and may for example be provide with couplings, vents, ports, etc., so that the housing can be coupled with house exhaust of a semiconductor manufacturing facility, or otherwise with a clean dry air (CDA) line to permit flow of gas therethrough as a safety measure to ensure against any leakage of the cleaning agent into the ambient environment of the facility in which the cleaning apparatus is used.

The unitary cleaning apparatus may be configured to service multiple ion implanters, e.g., by the provision of flow circuitry arrangements with multiple connections for respective ion implanters, and processor and controller components arranged for interfacing with multiple ion implanters. The unitary cleaning apparatus may have any appropriate conformation and form factor, as necessary or desirable in a given implementation of such apparatus for the intended usage thereof for cleaning ion implanters and/or components thereof.

The unitary cleaning apparatus in various embodiments may be arranged to provide on-board capability to cycle purge the ion implanter or component(s) thereof. For example, the unitary cleaning apparatus may include an on-board vacuum pump or other appropriate components for such purpose. Alternatively, the unitary cleaning apparatus may include processor and controller components that are adapted to effect purging operations by the ion implanter purging unit(s), under the direction and control of such processor and controller components of the unitary cleaning apparatus.

The unitary cleaning apparatus may in various embodiments also incorporate scrubbing capability, e.g., in the form of a chemisorbent or physical adsorbent material that is selective for the cleaning agent, so that any leakage of the cleaning agent from the supply vessel, flow circuitry or other components of the unitary cleaning apparatus is immediate sorbed and removed from the ambient environment of the leak.

The unitary cleaning apparatus in specific embodiments includes a plasma generator for remote plasma generation for the cleaning operation, involving subjecting the gas phase cleaning agent to ionization conditions to form a plasma cleaning agent.

The processor and controller components of the unitary cleaning apparatus can include hardware and software components that enable communication with remote data logging systems, or with facility automation systems, for integration of operations in the corresponding facilities. The processor and controller components can also be adapted to interface with a process control system of the implanter, to integrate the cleaning operation with the non-cleaning operation of the ion implanter. For example, when the unitary cleaning apparatus is arranged to introduce XeF₂ in place of argon carrier gas during the cleaning operation, and the cleaning operation is conducted at a pressure of 4 torr, when the ion implanter switches back to flowing argon at 10 psi (69.9 kPa) as a carrier gas for subsequent ion implant operation, there is a possibility that a harmful pressure spike might be sent to the source turbo pump. The unitary cleaning apparatus may therefore be adapted to interact with the process control system of the ion implanter to effect a gradual opening of the argon stick flow control valve after cleaning operation is terminated, to avoid such pressure spike from occurring. It will be recognized that the processor and controller components of the unitary cleaning apparatus may be otherwise adapted to buffer or modify transitions, including pressure as well as temperature, flow rate and other transitions in the ion implanter, which would otherwise occur in the transitions between ion implantation and cleaning operations, so that safety and efficiency in the respective transitions are maximized.

In various embodiments of the unitary cleaning apparatus, avoidance of undesirable condensation of the cleaning agent (e.g., XeF₂) may be accomplished by heating of the supply vessel(s) and/or flow circuitry, controlled modulation of temperature and pressure during delivery of the cleaning agent, nitrogen purging of delivery lines after cleaning agent delivery, periodic evacuation of delivery lines in the flow circuitry, cleaning agent supply vessel installation and orientation, and optimized cleaning frequency.

Thus, the disclosure contemplates a unitary cleaning apparatus for delivery of a cleaning agent to an ion implanter or component thereof, said apparatus comprising a housing, and structurally associated with said housing (i) at least one cleaning agent supply vessel, (ii) cleaning agent flow circuitry coupled to said at least one cleaning agent supply vessel, and (iii) a processor and controller components assembly adapted to effect dispensing cleaning agent from said at least one cleaning agent supply vessel for passage through said flow circuitry to said ion implanter or component thereof.

Thus, an ion implanter may be provided including a housing defining an enclosed interior volume, with a unitary cleaning apparatus as described above, operatively arranged in said interior volume for cleaning of the ion implanter or a component thereof, or positioned on a surface of or in proximity to the housing and operatively coupled with the ion implanter for cleaning of the implanter or a component thereof.

The disclosure further contemplates an endpoint detection system for a reactive gaseous cleaning agent cleaning operation, comprising an insert adapted for placement in an effluent stream of the cleaning operation and including a material exothermically reactive with the gaseous cleaning agent, said insert including a thermal monitoring element adapted to sense a temperature condition of said material indicative of presence of the cleaning agent in contact with said material.

In various embodiments, the disclosure contemplates a method of cleaning an ion implanter or component thereof, comprising flowing a cleaning agent to the ion implanter or component thereof from a source of said cleaning agent while operating a fluid delivery stick of the ion implanter in a manner enabling the cleaning agent to be flowed to said ion implanter or component thereof in place of or in addition to fluid delivered by said fluid delivery stick.

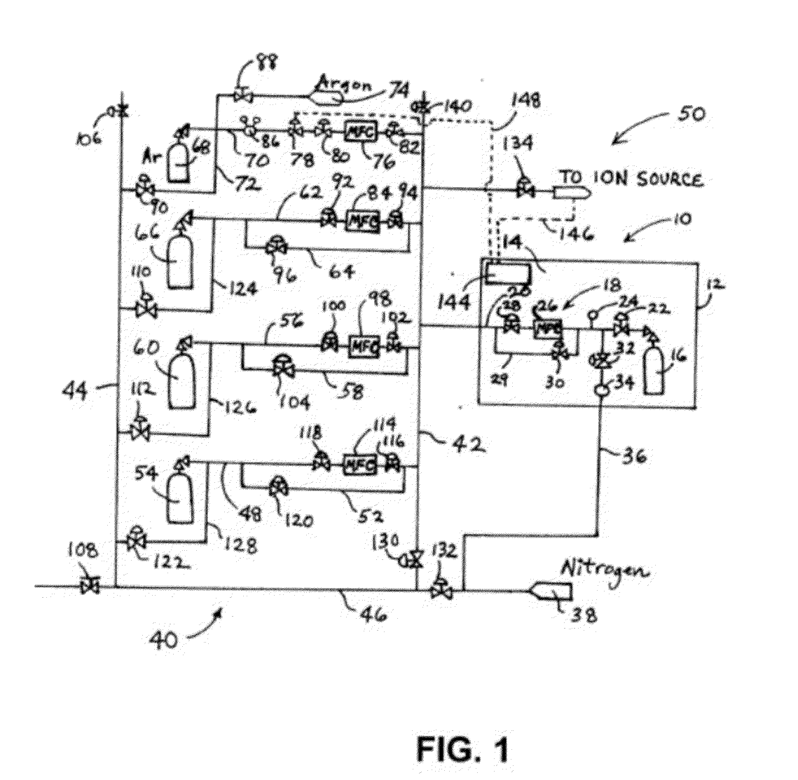

Referring now to the drawings, FIG. 1 is a schematic representation of a unitary cleaning apparatus 10 according to one embodiment of the present disclosure, as coupled to a four gas stick ion implanter 50. The unitary cleaning apparatus is arranged to deliver cleaning agent into an arc chamber of the implanter.

The implanter in this arrangement includes a manifolded arrangement of four gas sticks, including fluid delivery lines 48, 56, 62 and 70 respectively coupled with dopant supply vessel 54, dopant supply vessel 60, dopant supply vessel 66 and argon carrier gas supply vessel 68. Each of the fluid delivery lines 48, 56, 62 and 70 is joined at a downstream end thereof to fluid supply manifold 42 containing flow control valves 130 and 140.

Each of the fluid delivery lines 48, 56, 62 and 70 has an associated branch line 128, 126, 124 and 72, respectively, containing flow control valves 122, 112, 110 and 90, respectively, and joined to purge manifold 44 containing flow control valve 106.

Each of the fluid supply manifold 42 and purge manifold 44 are joined to nitrogen supply line 46 containing flow control valve 132 and valve 108 therein, with the nitrogen supply line 46 in turn joined to nitrogen gas supply 38, which may be a semiconductor manufacturing facility house nitrogen line.

In the implanter manifold arrangement, the argon stick including argon delivery line 70 is joined in flow communication with argon supply 74 via branch line 72 containing valve 88 therein. The argon supply 74 may be a semiconductor manufacturing facility house argon line. Thus, the argon stick is shown as being supplied by either argon from the argon supply 74, or from argon supply vessel 68, or both.

As illustrated, argon delivery line 70 contains fluid pressure regulator 86, flow control argon blocking valve 78, mass flow controller (MFC) 76 and valves 80 and 82 upstream and downstream, respectively, of the mass flow controller 76. Each of the remaining gas sticks is allocated to dopant delivery from dopant supply vessels 54, 60 and 66. The dopant delivery stick associated with dopant supply vessel 66 contains mass flow controller 84, upstream and downstream valves 92 and 94, with a bypass loop 64 containing flow control valve 96, to provide flow dopant bypassing the mass flow controller in line 62. The argon blocking valve is provided as a retrofit valve in some embodiments with the unitary cleaning apparatus, to accommodate the cleaning operation.

Correspondingly, dopant delivery line 56 contains mass flow controller 98 and the upstream and downstream flow control valves 101 and 12, with such dopant delivery line communicating with bypass loop 58 containing flow control valve 104. Constructed in similar fashion, the dopant delivery line 48 contains mass flow controller 114 and upstream and downstream valves 118 and 116, with bypass loop 52 containing flow control valve 120 being in fluid flow communication with line 48.

The unitary cleaning apparatus 10 is shown as including housing 12 defining an interior volume 14 therein. Disposed in such interior volume is a cleaning agent supply vessel 16. The cleaning agent supply vessel 16 is in fluid flow communication with the flow circuitry 18, comprising cleaning agent delivery line 20 containing flow control isolation valve 28, mass flow controller 26, pressure transducer 24, and flow control valve 22. The flow circuitry 18 includes a bypass loop 19 containing flow control valve 30, to permit flow of cleaning agent bypassing the mass flow controller. The pressure transducer 24 monitors pressure and is arranged to initiate certain control functions in the operation of apparatus 10.

Also coupled with the cleaning agent delivery line 20 is a nitrogen purge line 36, interconnecting the delivery line 20 with nitrogen supply line 46. The nitrogen supply line contains check valve 34 and flow control valve 32. By such arrangement with the nitrogen supply line, the flow circuitry 18 can be selectively purged, when the cleaning agent supply vessel 16 has become exhausted or otherwise reached an endpoint condition, and must be removed from connection with the flow circuitry and replaced with a fresh vessel of cleaning agent. It will be appreciated that the nitrogen purge capability may not be provided in the unitary cleaning apparatus in various embodiments of the disclosure, and that other purge or renewal capability may be provided, as an optional feature of the unitary cleaning apparatus.

Also disposed in the interior volume 14 enclosed by housing 12 is a processor and controller components assembly 144, which is coupled in signal transmission relationship with flow control valve 78 in the argon stick including argon delivery line 70, by signal transmission line 148. By this arrangement, the processor and controller components assembly 144 can modulate or close flow control valve 78, e.g., by a pneumatic or other type valve actuator associated with flow control valve 78. The processor and controller components assembly 144 also is shown as being linked in signal transmission relationship with the implanter via signal transmission line 146, whereby an endpoint condition of the cleaning operation can be sensed in the ion implanter and a signal responsively generated which is transmitted in signal transmission line 146 to the processor and controller components assembly 144, which then can actuate the opening of flow control valve 78, if same has been closed to accommodate cleaning operation. The processor and controller components assembly 144 can also be coupled in control relationship with flow control valve 22 associated with the cleaning agent supply vessel 16.

It will be understood that the signal transmission relationship of processor and controller components assembly 144 may be widely varied, to operatively control the cleaning operation and associated components, elements and parameters of the ion implanter system, consistent with the preceding discussion herein of the various modes of operation of the unitary cleaning apparatus of the present disclosure.

By the arrangement shown in FIG. 1, argon and dopants from supply vessels coupled with the fluid supply manifold may be flowed to the ion implanter in the line containing flow control valve 134, by appropriate opening of valves in the lines associated with the dopant supply vessel and argon supply vessel or argon supply 74. Subsequently, the cleaning operation may be commenced by closure of flow control valve 78 by action of the processor and controller components assembly 144, to thereby terminate supply of argon to the ion implanter. Concurrently, flow control valves 22 and 28 open in the cleaning agent supply line 20, so that cleaning agent flows through such line 22 to the fluid supply manifold 42 and then through the line containing valve 134 to the ion implanter. Cleaning then is carried out of the ion implanter or selected components or locations thereof, with the cleaning agent contacting the deposits at such locus or loci. The cleaning may include contact of the cleaning agent with the deposits in a continuous flow operation, or the cleaning agent may be introduced to the specific chamber or part to be cleaned in the implanter, to fill such component to a desired pressure, following which the cleaning reaction is allowed to take place for a predetermined time. Following such cleaning reaction, the component, now containing unreacted cleaning agent and reaction products, is evacuated, e.g., by action of the vacuum pump, roughing pump, or other device effecting evacuation, and such fill, soak and evacuation steps thereafter may be repeated, for as many cycles as are determined to be necessary. The flow of cleaning agent to the ion implanter may be pulsed, intermittent, or otherwise time-varying in any suitable manner appropriate to the particular cleaning application involved.

Following the cleaning action, the processor and controller components assembly 144 will actuate flow control valve 78 so it opens and delivers argon during subsequent ion implantation operation of the implant tool, with one or more dopants being provided from one or more of the supply vessels 54, 60 and 66. The cleaning action itself is terminated by closure of flow control valves 22 and 28. Thereafter, the flow circuitry 18 can be purged by nitrogen delivered from nitrogen supply line 46 and nitrogen purge line 36, when valve 32 is opened for the purge operation.

The unitary cleaning apparatus 10 thereby functions to provide a cleaning capability in an ion implanter that is only designed to accept four gas supply vessels (and wherein the implanter software interface is not programmed to recognize any more than four gas supply vessels), by providing the cleaning agent supply vessel as a fifth gas supply vessel enabling the ion implanter to practice processing recipes based on the argon stick. The unitary cleaning apparatus functions to block the argon flow via flow control valve 78 and replace it with the cleaning chemistry. The mass flow controller 26 functions to control the flow rate of cleaning agent from the cleaning agent supply vessel to a user-defined set point.

The unitary cleaning apparatus 10 thus can be readily coupled to and disengaged from the ion implanter by suitable connectors on cleaning agent delivery line 20, affording connection to and disconnection from the fluid delivery manifold 42, and on nitrogen purge line 36, affording connection to and disconnection from nitrogen supply line 46, such as may be desired if the unitary cleaning apparatus 10 is to be used on a temporary or intermittent basis requiring only short-term connection to the ion implanter for the cleaning operation. The signal transmission lines 146 and 148 may correspondingly be arranged for ready connection and disconnection. In specific embodiments, the processor and controller components assembly 144 may be adapted for wireless signal communication, thereby obviating the need for wired connection with such signal transmission lines.

Alternatively, the unitary cleaning apparatus 10 can be provided as a permanent retrofit to the ion implanter, to accommodate intermittent or periodic cleaning of the implanter or selected locations or components thereof.

Although the unitary cleaning apparatus of the present disclosure is variously described herein as being utilized for delivery of cleaning agent to an industrial tool such as a semiconductor manufacturing tool, e.g., an ion implanter apparatus for cleaning thereof, it will be recognized that the unitary apparatus of the disclosure may additionally, or alternatively, be used for delivery of materials other than cleaning agents, and may be used in various other industrial equipment. For example, the unitary apparatus of the disclosure can be employed in application to process system installations having limited numbers of flow lines or flow circuitry sticks, for delivery of additional materials to the process system, such as an additional co-flow gas that is introduced to the flow circuitry to augment the capability of the process system. The unitary apparatus can thus find application for delivery of additional reactants, diluents, control agents, entrainment fluids, or other materials to process systems of widely varying types.

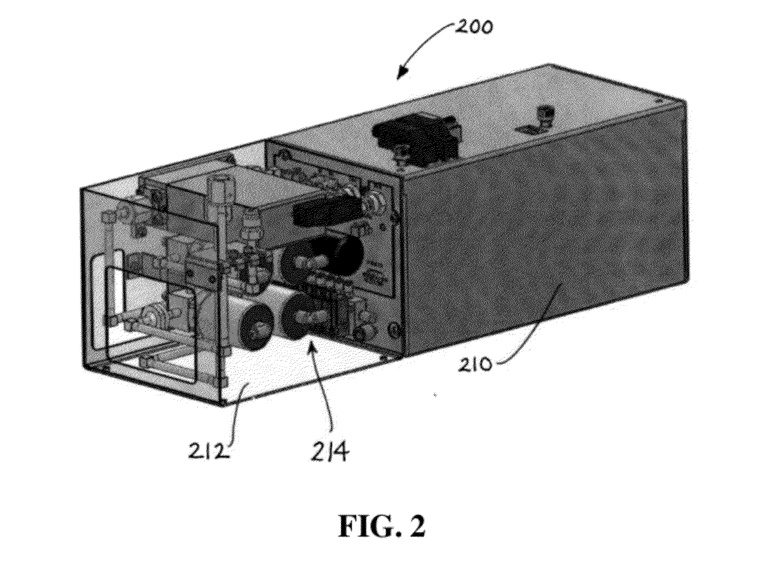

FIG. 2 is a perspective semi-transparent view of a unitary cleaning apparatus 200 according to another embodiment of the disclosure. As illustrated, the apparatus 200 comprises a housing 210, wherein the housing encloses an interior volume 212 containing flow circuitry 214. The unitary cleaning apparatus may include multiple cleaning agent supply vessels, arranged with suitable manifolding to ensure continuity of cleaning operation involving the capability of switching from a fluid-depleted vessel to a fresh vessel, and optionally an empty-detect device or arrangement for determining approach of an onstream cleaning agent supply vessel to a depleted state, arranged to initiate such switching. The flow circuitry 214 includes various valves, mass flow controller and the pressure transducer 203. The pressure transducer 203 is arranged to monitor the manifold pressure and initiate various control functions. The processor and controller components assembly of the unitary cleaning apparatus in FIG. 2, corresponding to the assembly 144 schematically shown in FIG. 1, is mounted in the enclosed housing 210 and thus is not visible in the FIG. 2 drawing, but includes a programmable logic controller (PLC), power supplies and related components.

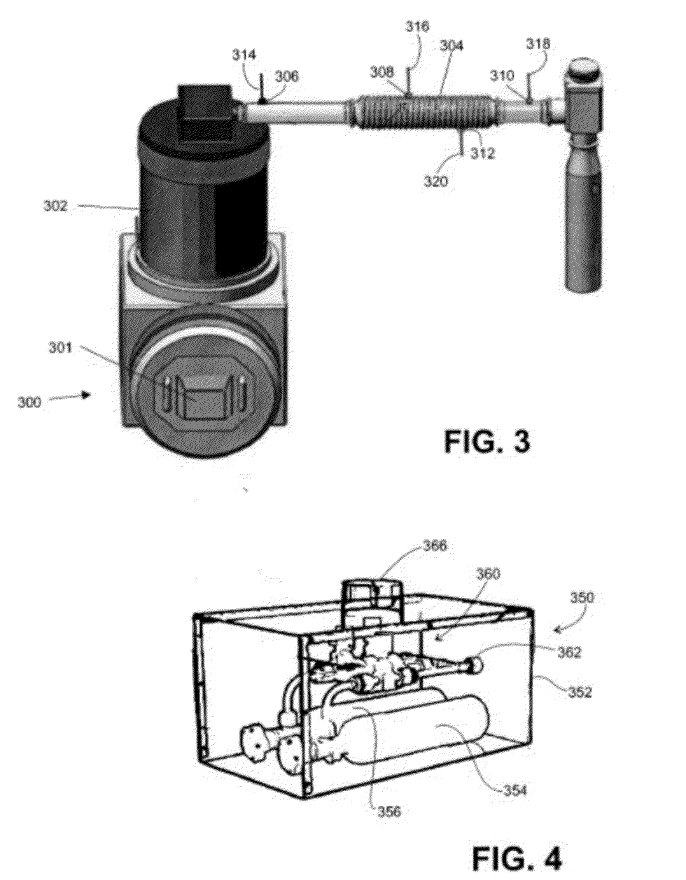

FIG. 3 is a perspective view of various components of an ion implanter 300, including source chamber 301, turbo pump 302, and fore-line 304. Coupled to the fore-line 304 are various thermocouples 306, 308, 310 and 312, with extending portions 314, 360, 318 and 320 that may be coupled in signal transmission relationship to processor and controller components for monitoring the cleaning reaction. The cleaning agent, e.g., XeF₂, is introduced from the unitary cleaning apparatus (not shown in FIG. 3) to the source chamber 301 and flows from the source chamber 301 through the turbo pump 302, along the fore-line 304 and is discharged. The discharged cleaning agent and reaction product effluent may then be passed to a scrubber for treatment of the effluent and/or recovery of unreacted XeF₂. The unitary cleaning apparatus thereby functions to remove residue deposits in the source chamber, turbo pump and foreline components of the implanter 300.

FIG. 4 is a perspective semi-transparent view of an integrated unitary cleaning apparatus 350 according to another embodiment of the disclosure. The unitary cleaning apparatus in this embodiment includes a housing 352 enclosing an interior volume in which is disposed an arrangement of two cleaning agent supply vessels 354 and 356 together with associated flow circuitry 360, and integrated connection ports 362 for delivery of the cleaning agent to the implanter or selected component(s) thereof to be cleaned, for connection to a source of pressurized gas for actuation of the various valves in the flow circuitry, and for connection to a nitrogen purge gasify, for purging the flow circuitry. An exhaust connection 366 is provided for coupling with a house exhaust system of the implanter facility, or other exhaust system. The housing may be provided with an access panel for servicing of the valves and other components of the unitary cleaning apparatus.

The unitary cleaning apparatus 350 shown in FIG. 4 may be of relatively small size in a typical configuration. In one embodiment, the apparatus is enclosed in a housing having a width of 12 inches, a length of 20 inches and a height of 10 inches, thereby providing an extremely compact unit with a correspondingly small footprint. A unitary cleaning apparatus of such compact character is readily installed within or on top of an implanter enclosure, thereby minimizing its impact on the floor space and overall configuration of the implanter facility.

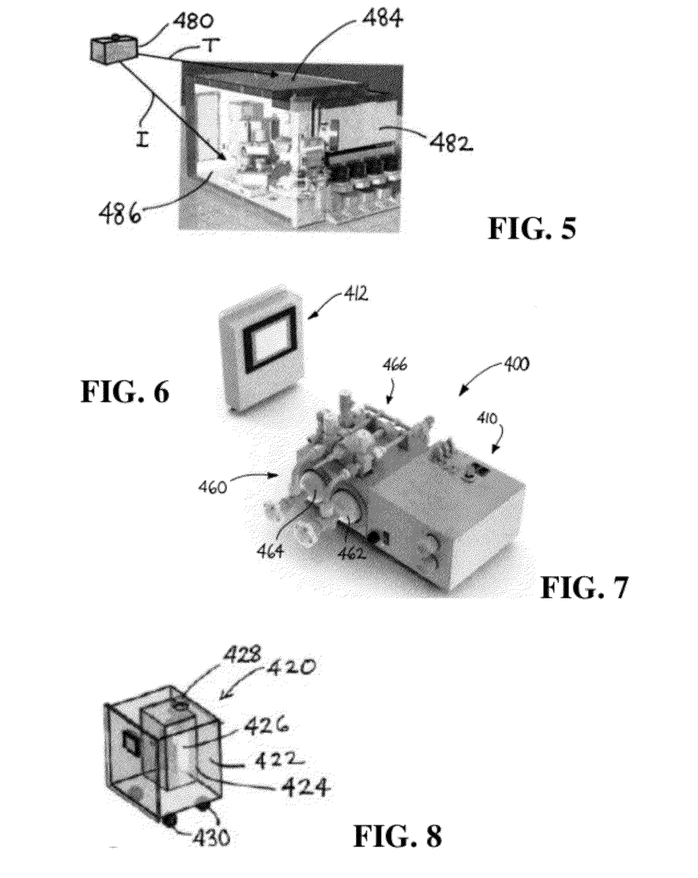

FIG. 5 is a perspective semi-transparent view of an ion implanter 482 and an integrated unitary cleaning apparatus 480 of the type illustrated in FIG. 4, showing alternative locations of the ion implanter at which the integrated unitary cleaning apparatus can be mounted. As illustrated in FIG. 5, the unitary cleaning apparatus 480 can be installed on a top surface 484 of the ion implanter, as indicated by arrow T. Such configuration is usefully employed with implanters of a type including post acel capability. FIG. 5 also shows an alternative arrangement, in which the unitary cleaning apparatus 480 is installed in the interior volume 486 of the ion implanter 482, as indicated by arrow I. Such interior disposition of the unitary cleaning apparatus is usefully employed with implanters of a type lacking post acel capability, with the unitary cleaning apparatus being at the implanter ground.

FIG. 6 is a perspective view of an operator interface panel 412 for the unitary cleaning apparatus of the disclosure.

FIG. 7 shows an electrical control box 410 of the unitary cleaning apparatus 400, arranged adjacent to the fluid supply assembly 460 of the cleaning apparatus. The electrical control box 410 houses all electrical equipment and the programmable logic controller (PLC) necessary to perform the cleaning operation. Such control box may be of relatively small size, and in one embodiment has dimensions of 10 inches×10 inches×10 inches. The control box may be equipped with fiber-optic communications capability, for transmission and receipt of monitoring and control signals, and the control box may be equipped with a manual switch located inside the enclosure to provide interlock capability.

The operator interface panel 412 shown in FIG. 6 provides the capability to initiate cleaning routines, and enables data logging and display functions as well as status indication.

The electrical control box 410 and operator interface 412 can be provided as separate components of the unitary cleaning apparatus, or may be integrated into a single package assembly. The operator interface may be provided with interlock features such as keyed switches, and may be adapted for operation using wireless communications technology.

The fluid supply assembly 460 of the cleaning apparatus shown in FIG. 7 includes cleaning fluid supply vessels 462 and 464, each coupled to flow circuitry 466 including flow control components that are actuatable to initiate dispensing of cleaning fluid, e.g., from one of the vessels 462 and 464 while the other is off-stream, in a manifolded arrangement useful for cyclic operation. In such cyclic operation, the on-stream fluid supply vessel as it approaches exhaustion during dispensing service is switched out of service by appropriate valve closure, and switch-over of dispensing operation occurs to the other, fresh vessel holding cleaning fluid, to thereby achieve continuity of dispensing and the cleaning operation.

FIG. 8 is a perspective semi-transparent view of a mobile unitary cleaning apparatus 420, according to another embodiment of the disclosure. As shown, such apparatus includes an outer housing 422 within which is provided an inner housing 424 containing the non-electrical components of the cleaning apparatus (i.e., cleaning agent supply vessel(s), flow circuitry, etc.), so that the electrical components are isolated from the non-electrical components. The electrical components including an integrated operator interface are provided on a front door panel on the left-side of the outer enclosure as illustrated. An exhaust connection 428 is provided on a top panel of the outer enclosure, communicating with the interior volume and the inner enclosure, and may be connected to a house exhaust system or other exhaust system.

A handle may be provided on the outer housing, to facilitate manual movement of the mobile unitary cleaning apparatus within an ion implanter facility, and for such purpose the outer enclosure is mounted on casters 430 to provide ready manual manipulative ability in transport of the apparatus from one location to another within the ion implanter facility.

By the arrangement illustrated, the unitary cleaning apparatus shown in FIG. 8 contains space inside the outer enclosure for storage of fluid delivery lines and other equipment usefully employed with the cleaning apparatus, with the inner enclosure containing the cleaning agent supply vessels and associated manifolding, valves, etc. being exhausted through the exhaust connection 428, in a small sized and readily mobile assembly.

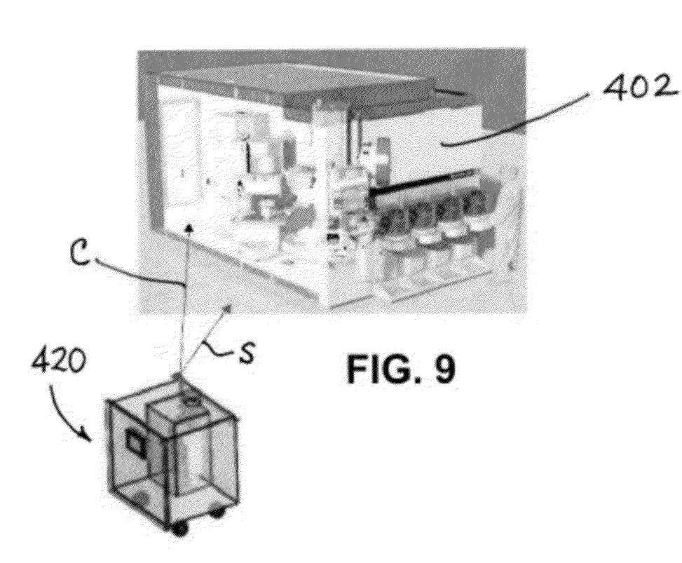

FIG. 9 is a perspective semi-transparent view of an ion implanter 402 and the mobile unitary cleaning apparatus 420 of FIG. 8, showing the possible positioning of the mobile apparatus in relation to the ion implanter, as being located on the floor beside the implanter (position indicated by arrow S) or alternatively as being located in the enclosure of the ion implanter (position indicated by arrow C). It will be recognize that the mobile unitary cleaning apparatus may be adapted for cleaning of one or concurrently more than one ion implanter.

The mobile unitary cleaning apparatus thus may be brought to the implanter for cleaning thereof, at which time an exhaust line may be interconnected with the exhaust connection and all delivery lines and associated connections are prepared for the cleaning operation. The mobile apparatus may be located just outside the implanter enclosure or within the enclosure itself. After cleaning, during an idle state, the mobile apparatus can be connected to an exhaust structure so that the apparatus is ventilated and exhausted during storage. The mobile unitary cleaning apparatus is advantageously equipped with tool interlocks to ensure safety of operation. Toxic gas monitoring capability may be provided in the cleaning apparatus enclosure, or connection provided for coupling with a monitoring capability of the implanter facility. The mobile apparatus may further include an onboard battery or other power supply, so that externally supplied power is not needed during the cleaning operation.

The unitary cleaning apparatus of the present disclosure may be widely varied in use and application. The apparatus may include cleaning agent vessel heating capability, such as by provision of a thermocouple or other temperature sensor on the cleaning agent supply vessel to enable heating to a set point temperature condition. Heating capability may be arranged to heat the cleaning agent supply vessel to a predetermined output pressure, to suppress condensation, and vessel heaters may be arranged for pulsed heating. High conductance flow circuitry including high conductance valves, e.g., valves having a flow conductance, Cv, of at least 0.7, such as valves for which Cv is from 0.7 to 2.5, more preferably from 0.8 to 2.0, and most preferably from 0.9 to 1.2, may be employed to provide high flow rates of cleaning agent to the ion implanter or component thereof to be cleaned. The apparatus may be provided with cycle purging capability and onboard vacuum generation or the capability to utilize the ion implanter vacuum system. Onboard scrubbing capability may be provided, to accommodate any leakage of the cleaning agent in the apparatus.

The unitary cleaning apparatus may further comprise in the processor in controller components a program capability involving stored cleaning recipes providing various modes of cleaning operation, including fill and soak cleaning, flow-through cleaning or constant bleed introduction of cleaning agent to the ion implanter or component thereof to be cleaned. A remote plasma generator may be provided in the unitary cleaning apparatus, for beam-line cleaning operations, and capability for communication with ion implanter facility automation systems may be provided.

Endpoint detection capability may be provided in the unitary cleaning apparatus, to determine an endpoint condition at which cleaning has been completed, whereupon the cleaning apparatus may be shut down. Such endpoint detection capability may involve monitoring pressure change during a soak time (dP/dt monitoring), so that once such pressure differential does not change with time, the cleaning operation is evidenced as being completed. The endpoint detection capability may be based on a parameter of the ion implanter, temperature level, temperature sensing by a thermocouple or other thermal monitoring element, or use of a sacrificial part that is in line with the cleaning locus, so that the cleaning agent causes erosion or elimination of a sacrificial part as the endpoint determinant, e.g., by erosion or elimination that alters an electrical current path. FTIR detection of the cleaning effluent may be carried out to determine the endpoint condition of the cleaning.

Correspondingly, empty detect arrangements can be employed to determine the onset of exhaustion of cleaning agent from the cleaning agent supply vessel being used to dispense cleaning agent to the cleaning operation. Such empty detect arrangements may involve pressure-based or rate of change of vessel pressure determination to utilize the phenomenon of pressure dropping more rapidly as the supply vessel approaches depletion. The empty detect arrangements may be flow-based in character, or may be based on calculation or determination of the amount of cleaning agent used versus an original fill weight or fill weight measured at a prior time. The empty detect arrangements may be weight-based, involving monitoring of the weight of the vessel during the cleaning agent dispensing operation.

In applications such as beam-line cleaning, involving the presence of graphite components, graphite intercalation of undesired components such as fluorine can be addressed by fill pressure or species mix changes as a result of specific operational parameters of the cleaning.

Condensation issues can be minimized or avoided by vessel and delivery line heating, optimization of vessel heating with early turn-off for temperature and pressure control during delivery, backfilling of fluid passages and components with nitrogen after cleaning agent flow, periodic evacuation of delivery lines, installation and orientation of the cleaning agent supply vessel(s) and optimization of cleaning frequency.

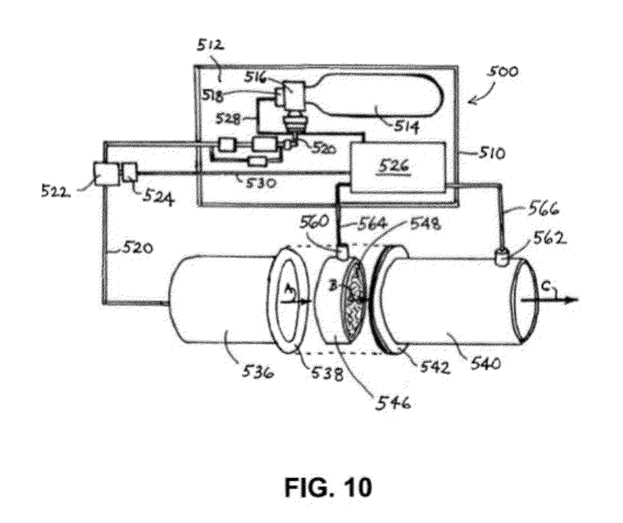

FIG. 10 is a schematic representation of an illustrative end point detection system that may be usefully employed with a unitary cleaning apparatus 500.

The cleaning apparatus 500 is shown as including a housing 510, defining an interior volume 512 in which is disposed a cleaning agent supply vessel 514 with a valve head 516 and valve head actuator 518. The cleaning agent supply vessel 514, when the valve in valve head 516 is open, dispenses cleaning agent into cleaning agent delivery line 520 containing flow control valve 522 therein. Valve 522 is associated with a valve actuator 524. A processor and controller components assembly 526 is also provided in the interior volume 512 of the housing 510, and is coupled by signal transmission line 528 to valve head actuator 518, and by signal transmission line 530 to valve actuator 524.

The cleaning agent delivery line 520 delivers cleaning agent to an ion implanter or component thereof to be cleaned (illustratively shown in FIG. 10 by tubular section 536 representing a foreline, beamline or other component of the ion implanter) communicating with exhaust conduit 540, wherein the tubular section 536 and the exhaust conduit 540 are shown as having respective flanges 538 and 542 that may be coupled to one another to provide for flow of cleaning agent through the coupled elements.

An endpoint sensing insert 546, in the form of a cylindrical member sized to fit between the tubular section 536 and the exhaust conduit 540 is provided. The insert 546 is open to accommodate flow of cleaning agent therethrough (so that cleaning fluid flows in the direction indicated by successive arrows A, B and C in FIG. 10 through the tubular section 536, insert 546 and exhaust conduit 540), and is provided on its inner cylindrical surface with a coating 548 of the material that is exothermically reactive with the cleaning agent, to provide corresponding heating of the cylindrical insert. The cylindrical insert is provided with a thermocouple 564 arranged to sense the temperature of the insert 546 and responsively generate a sensing signal that is transmitted in signal transmission line 564 to the processor and controller components assembly 526 in the unitary cleaning apparatus 500.

In lieu of an insert of the type shown, any suitable structure or component(s), e.g., probes, cavity structures, sidestream passages, etc., can be alternatively employed to enable deposition of residues to accumulate thereon, to provide a capability for detecting when cleaning is necessary.

A thermocouple 562 is correspondingly provided in exhaust conduit 540 and is arranged to output a temperature sensing signal in signal transmission line 566 to the processor and controller components assembly 526 in the cleaning apparatus 500.

By this arrangement, the processor and controller components assembly 526 receives the temperature sensing signals from thermocouples 560 and 562, and responsively outputs control signals in signal transmission lines 528 and 530 for actuating valve actuators 518 and/or 522, respectively, so that flow control valve 522 and the dispensing control valve in the valve head 516 are modulatable during the cleaning operation to vary the flow in response to the differential temperature sensing between thermocouples 560 and 562, and to terminate cleaning operation when the differential temperature sensing between thermocouples 560 and 562 indicates that the cleaning operation has been completed. It will be appreciated that the processor and controller components assembly 526 may be arranged in specific embodiments to actuate only one of such valves, or to actuate other valves in the unitary cleaning apparatus and/or ion implanter, and/or to provide other output or action indicative of the completion of the cleaning, such as a graphical output on a display, actuation of an alarm, or other shutdown or responsive operation.

The arrangement shown in FIG. 10 is highly advantageous for use of xenon difluoride as the cleaning agent, since if flow of xenon difluoride through ion implanter chambers and pumps is continued after cleaning has been completed, condensation of the cleaning agent can occur. This may in turn cause restriction in exhaust lines and degrade pump performance. It therefore is highly desirable to terminate the flow of the cleaning agent as soon as cleaning is completed, and such capability is provided by the reactive insert arrangement shown in FIG. 10.

In various embodiments, the endpoint detection system of the type shown in FIG. 10 can be utilized in ion implanters in which the cleaning is carried out programmatically for a specified period of time, e.g., by means of a cycle-time program. In such applications, the differential temperature monitoring by the endpoint detection system can be used in an override capacity, if the cleaning operation has not been completed by the programmed time allotted for such operation, so that the endpoint detection system responsively extends the duration of the cleaning operation, to ensure the desired removal of deposits in the ion implanter or components thereof being cleaned.

It will be appreciated that the endpoint detection system shown in FIG. 10 is of an illustrative type and that the arrangement and components thereof can be substantially varied in the broad practice of the disclosure. For example, instead of the coating 548 on the inner cylindrical surface of tubular section 536, the active component of the endpoint detection system could be a probe coated with a material exothermically reactive with the cleaning agent, and operatively linked to temperature monitoring and signal generation components, or a thermocouple element can be coated with such material, or other arrangement may be employed, using one or more monitoring components that are arranged for endpoint monitoring service.

The unitary apparatus of the disclosure therefore provides a capability for introducing fluid agents to process systems lacking sufficient existing fluid delivery capacity for such fluid agents, due to limitations of existing flow circuitry, gas delivery sticks, etc., and in application to cleaning of ion implanters, provides an augmentive cleaning function that can substantially reduce the mean time between failures of system components of the ion implanter, and increase the on-line time of the implanter and its efficiency.

The features and advantages of the apparatus and methods of the disclosure are more fully apparent from the ensuing non-limiting examples.

### Example 1

An 8250 medium current implanter experienced glitching due to coatings on a suppression feed through an insulator resulting in a 6-week periodic maintenance schedule being required. A unitary cleaning apparatus of the present disclosure was utilized to effect cleaning of the implanter with xenon difluoride. As a result, the periodic maintenance interval was extended to 10 weeks and glitching was reduced.

### Example 2

Cleaning of a Kestrel high energy tool was carried out with a unitary cleaning apparatus of the present disclosure, resulting in effective cleaning of source chamber housing deposits.

### Example 3

Using a unitary cleaning apparatus of the disclosure, xenon difluoride was used to clean deposits within a Lleybold mag-lev turbo pump on a Kestrel tool. Following the xenon difluoride exposure, the turbo pump was fully cleaned with all visual signs of deposits removed and operated as expected.

### Example 4

A Pfeiffer TMP1000C turbo pump previously installed on an xR80 ion implanter processing BF₃, PH₃, AsH₃ and GeF₄ was removed from the tool because it would not spin. Cleaning with xenon difluoride delivered by a unitary cleaning apparatus of the present disclosure was effective and the pump was able to spin up after cleaning.

### Example 5

Ex situ cleaning with xenon difluoride delivered by a unitary cleaning apparatus of the present disclosure was conducted on a Pfeiffer TPH2101 turbo pump that was previously connected to a Varian HCi high current implanter. The cleaning was effective in removing known deposits.

### Example 6

A unitary cleaning apparatus of the present disclosure was utilized for cleaning of a Kestrel high energy tool running 60/40% PH₃ and BF₃ with an additional 10 g of magnesium each week. This tool had previously experienced several fires. The cleaning was conducted with xenon difluoride, and was successful in removing the deposits and returning the pipe surface to bare metal upon completion of the cleaning operation.

### Example 7

Ex situ cleaning of a turbo pump fore-line of a Varian HCi high current tool brought the pipe surface back to bare metal after cleaning with xenon difluoride delivered by a unitary cleaning apparatus of the present disclosure.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A unitary cleaning apparatus for delivery of a cleaning agent to an ion implanter or component thereof, said apparatus comprising a housing, and structurally associated with said housing:
(a) at least one cleaning agent supply vessel,
(b) cleaning agent flow circuitry coupled to said at least one cleaning agent supply vessel, and
(c) a processor and controller components assembly adapted to effect dispensing cleaning agent from said at least one cleaning agent supply vessel for passage through said flow circuitry to said ion implanter or component thereof.

2. The unitary cleaning apparatus of claim 1, further comprising at least one of:
an empty-detect system for determination of a predetermined empty condition of a said cleaning agent supply vessel; and
fluid substitution components arranged for coupling with a fluid delivery stick of the ion implanter to enable the cleaning agent to be flowed to said ion implanter in place of or in addition to fluid delivered by said fluid delivery stick.

3. The unitary cleaning apparatus of claim 1, wherein the processor and controller components assembly are programmatically adapted to effect such cleaning according to a predetermined operational sequence, and wherein the apparatus further comprises:
(I) fluid substitution components arranged for coupling with a fluid delivery stick of the ion implanter to enable the cleaning agent to be flowed to said ion implanter in place of or in addition to fluid delivered by said fluid delivery stick, wherein the fluid substitution components comprise a fluid blocking valve adapted to close the fluid delivery stick to flow of fluid from a source connected in flow communication with said fluid delivery stick;
(II) an endpoint detection system coupled with said processor and controller components assembly, wherein the endpoint detection system comprises a material arranged for contact with the cleaning agent and exothermically reactive therewith, and a thermal monitoring element adapted to sense a temperature condition of said material indicative of presence of the cleaning agent in contact with said material;
(III) XeF₂ as the cleaning agent; and
(IV) wheels or casters for movement of the apparatus.

4. The unitary cleaning apparatus of claim 1, as operatively arranged to clean an ion implanter or component thereof.

5. A method of cleaning an ion implanter or component thereof, comprising flowing a cleaning agent to the ion implanter or component thereof from a source of said cleaning agent while operating a fluid delivery stick of the ion implanter in a manner enabling the cleaning agent to be flowed to said ion implanter or component thereof in place of or in addition to fluid delivered by said fluid delivery stick.

6. The method of claim 5, wherein the cleaning agent comprises XeF₂, and the cleaning is monitored by a monitoring system operative to determine an endpoint of the cleaning operation and responsively terminate the cleaning operation, comprising use of a material contacted with effluent from the cleaning operation and exothermally reactive with the cleaning agent.

7. A method of cleaning one or more components of at least one ion implantation system, the method comprising:
connecting a cleaning agent delivery system to an existing port of the at least one ion implantation system;
introducing a cleaning agent from the cleaning agent delivery system into the at least one ion implantation system through the existing port;
contacting the cleaning agent with deposits in the at least one ion implantation system under conditions effecting at least partial removal of said deposits;
detecting an endpoint of cleaning; and
responsively terminating delivery of the cleaning agent.

8. The method of claim 7, wherein the method is characterized by at least one of the features of:
(i) the existing port being arranged to deliver a first material, wherein said introducing is in place of or in addition to the first material;
(ii) the at least one ion implantation system comprising a plurality of ion implantation systems;
(iii) said introducing comprising use of the flow control device including at least one of a mass flow controller, pressure control valve, restrictive flow orifice, needle valve, and calibrated length of tubing;
(iv) providing an interlocked flow signal to the at least one ion implantation system, to initiate said introducing of said cleaning agent;
(v) monitoring at least one of temperature, pressure and time, in said detecting of the endpoint;
(vi) using at least one of a temperature probe and one or more thermocouples arranged to detect a temperature differential, in said endpoint detecting;
(vii) using a thermal monitoring element coated with a material exothermically reactive with the cleaning agent, in said endpoint detecting;
(viii) the existing port comprising a gas stick connection, gauge connection, or valve;
(ix) heating of the cleaning agent;
(x) providing xenon difluoride as the cleaning agent; and
(xi) back-filling with gas, wherein said back-filling at least partially evacuates the cleaning agent from the at least one ion implantation system.

9. The method of claim 7, wherein the cleaning agent comprises XeF₂.

10. A cleaning assembly that is selectively coupleable with one or more components of at least one ion implantation system for cleaning thereof, said assembly comprising:
at least one cleaning agent container and manifold arranged to deliver a cleaning agent to the one or more components of the at least one ion implantation system; and
a flow control device for introducing said cleaning agent;
wherein the assembly is adapted to be connected to an existing port of the at least one ion implantation system.

11. The assembly of claim 10, wherein the existing port is arranged to deliver a first material and the flow control device is adapted to introduce said cleaning agent in place of or in addition to the first material, wherein said assembly is mobile, wherein said assembly is adapted to be connected to an existing port of the at least one ion implantation system, comprising a gas stick connection, gauge connection, or valve, and wherein the flow control device comprises at least one of a mass flow controller, pressure control valve, restrictive flow orifice, needle valve, and calibrated length of tubing.

12. The assembly of claim 10, wherein at least one of the assembly and the at least one ion implantation system comprises an endpoint detection apparatus adapted to monitor at least one of temperature, pressure and time.

13. The assembly of claim 10, wherein the endpoint detection apparatus comprises a thermal monitoring element coated with a material exothermically reactive with the cleaning agent.

14. The assembly of claim 10, wherein the at least one cleaning agent container comprises a plurality of containers, and the assembly further comprises an automated container switch adapted to introduce the cleaning agent from an alternate cleaning agent container upon detection of an empty-detected primary cleaning agent container.

15. The assembly of claim 10, further comprising an empty container detector including at least one of a pressure sensor, flow sensor, and weight sensor.

16. The assembly of claim 10, wherein the at least one cleaning agent container holds XeF₂.

17. An end-point detection apparatus configured for use with an ion implantation system during cleaning of the ion implantation system with a cleaning agent, said apparatus comprising:
a material exothermically reactive with the gaseous cleaning agent, and a thermal monitoring element adapted to sense a temperature condition of said material indicative of presence of the cleaning agent in contact with said material.

18. The apparatus of claim 18, comprising an insert adapted for placement in an effluent stream of the cleaning operation, wherein the insert comprises said material exothermically reactive with the gaseous cleaning agent, and said thermal monitoring element.

19. The apparatus of claim 18, further comprising a processor and controller components assembly adapted to terminate the cleaning operation under an endpoint detection condition.

20. The apparatus of claim 18 wherein the material is reactive with XeF₂.
